(19) United States
(12) Patent Application Publication
(10) Pub. No.: US 2005/0019552 A1
(43) Pub. Date: Jan. 27, 2005

(54) Physical and thermal protective coating

(76) Inventors: Jack Wiersma, Palm Beach Gardens, FL (US); John Rothman, Lebanon, NJ (US)

Correspondence Address: Michael A. Slavin, Esq.;McHale & Slavin, P.A., 2855 PGA Boulevard, Palm Beach Gardens, FL, 33410, US

(21) Appl. No.: 10/625,477

(22) Filed: Jul. 21, 2003

(51) Int. Cl. B05D 3/02; B32B 9/04

(52) U.S. Cl. 428/325; 427/372.2; 428/446

(57) ABSTRACT

The invention provides a strong, corrosion resistant protective coating comprising a homogeneous mixture of polyurea and microscopic granules capable of imparting the property of diffuse reflectivity and emissivity and its method of use as a means for reduction of thermal and radiant energy transmission and absorption as well as damage due to water, corrosion or mechanical forces when applied to the outer surface of an object or container.

### FIELD OF THE INVENTION

The instant invention relates generally to the field of reduction of thermal and radiant energy transmission and absorption; more particularly to the use of protective coatings for such reduction of thermal and radiant energy transmission and absorption; and most particularly to a strong, protective, waterproof; corrosion resistant coating comprising a homogeneous mixture of polyurea and microscopic granules capable of imparting the property of diffuse reflectivity and emissivity and its method of use as a means for reduction of thermal and radiant energy transmission and absorption when applied to the outer surface of an object or container.

### BACKGROUND OF THE INVENTION

Protective-coatings applied to the outer surfaces of containers can have profound effects on the contents stored inside the containers. A protective coating which has properties that enable reduction of thermal and radiant energy transmission and absorption will reduce the thermal exposure/history of the container's contents, thereby enhancing shelf-life and preventing undesirable expansion of said contents.

Heretofore, industry has provided technology such as water based acrylic coatings, some including ceramics or borosilicates, to achieve reflectivity of solar heat on surfaces; primarily roofs, see for example U.S. Pat. No. 6,245,850 issued to John Fields on Jun. 12, 2001. These water based acrylic coatings, although proven effective in the reduction of heat generation have substantial limitations, among which are inferior strength, minimal, if any structural support, low scratch and impact resistance, low chemical resistance and minimal corrosion resistance. Furthermore, the currently used coatings require up to 10 days to cure, a parameter which slows down or interferes with timely applications and increases their cost.

Current technology, in many instances, requires multiple applications to achieve the required results and this further slows down the application process. Additionally, the water based acrylic coatings require a white or bright white pigment to function properly for the reduction of heat absorption. This reduces the aesthetic quality of the coatings by limiting diversity of coating colors available in the marketplace.

As an alternative, epoxy resin coatings have also been provided in the prior art for surface protective purposes which require diverse chemical resistant properties (see for example U.S. Pat. No. 5,936,022 issued to John Freeman on Aug. 10, 1999). These types of epoxy coatings are highly toxic and thus pose both health and environmental problems in their application and removal. This toxicity increases the costs of use of the epoxy coatings.

Although prior artisans have produced protective coatings that were either strong and non-corrosive or able to reduce heat absorption/transmission, they have been unable to producer a protective coating possessing both of these valuable properties.

What is thus lacking in the art is a strong, corrosion resistant and easily applicable protective coating that is able to provide a reduction of thermal and radiant energy transmission or absorption, thereby reducing temperature increase of outer surfaces to which they are applied and concomitantly reducing the thermal exposure of any contents beneath the treated surface.

### DESCRIPTION OF THE PRIOR ART

EERS International, Inc., a Fort Lauderdale, Fla. based company, provided two products, CERAMICOAT and TOTAL SHIELD, to the government one of which (Ceramicoat®) is registered with the ENERGY STAR roof products program (as reported on the FEMP (Federal Energy Management Program) webpage; News and Events: FEMP Focus, March/April 2002, “Reflective Roofing Systems Save Energy at Federal Facilities”, site accessed on Jul. 11, 2003).

The work done with EERS products in the creation of an ENERGY STAR approved roof was a three step process. The first step is the application of a sprayed-on polyurethane foam base. The polyurethane foam provides insulation, structure and contouring for drainage. The second step is the coating of the polyurethane foam base with TOTAL SHIELD polyurea. TOTAL SHIELD polyurea permanently seals the polyurethane-foam with a seamless, flexible, tough, water and chemical resistant membrane. The final step involves the application of a highly reflective, highly emissive and insulating topcoat (CERAMICOAT) containing small, hollow borosilicate spheres. This topcoat provides the roof with high solar and ultraviolet reflectance and high infrared emittance. These ENERGY STAR roofs were shown to reduce peak surface temperatures.

Although the protective coating of the instant invention utilizes two of the same ingredients (polyurea and borosilicate spheres) as ENERGY STAR, the instantly disclosed protective coating differs in a number of parameters, which result in a more efficient and cost effective product with great utility in applications other than roofs.

The composition of the instant invention is different than that of the products currently registed with the DoE ENERGY STAR program. Use of those products involves the application of separate layers, one layer of polyurea and a layer of and elastomeric acrylic reflective coating that contains borosilicate microspheres, while the instant invention mixes borosilicate microspheres within the polyurea. The homogeneous mixture of the instant invention was shown to provide greater initial solar reflectance than the layers of Ceramicoat (80% for ENERGY STAR and 80.7% for the instant invention, as set forth in the DoE Energy Star Approved Product Listing for Roof Products Qualifying Products List As of Nov. 28, 2002).

Thus, use of the protective coating of the instant invention provides advantages over that of the, Ceramicoat/Totalshield roofing product/system in that it can be applied in one, easy, cost-effective step and it provides, greater reduction of thermal and radiant energy transmission/absorption.

### SUMMARY OF THE INVENTION

The instant invention provides a strong dent and damage resistant, waterproof, corrosion resistant protective coating that is able to reduce the temperature of outer surfaces and thereby decrease heat absorption through said surfaces. This unique coating is capable of protecting containers and their contents. The protective coating comprises a highly cross-linked and dense homogeneous mixture of polyurea and micro to nanometer sized granules. This homogeneous mixture provides great strength, structural support, scratch and impact resistance, waterproofing, chemical resistance and corrosion resistance. Additionally, the protective coating of the instant invention reduces the ability of radiant energy (including electromagnetic radiation such as solar radiation) to increase the temperature of surfaces. By eliminating a majority of the portion of heat that results from incident radiation impinging on the exterior of the containers this protective coating has a profound effect on the internal temperature of the contents of these containers. In this way the contents of containers that-are prone to spoilage as a result of heat exposure are protected; contents which are prone to expand and thus minimize container capacity are limited in their expansion resulting in a higher vessel capacity; and, similarly, any physical or chemical changes that result from increased heat are minimized. Containers last longer, their contents last longer, and their carrying capacities for materials prone to heat expansion are increased.

Accordingly, it is an objective of the instant invention to provide a protective coating composition comprising a homogeneous mixture of polyurea and components that impart reflective, emissive and insulating properties.

It is another objective of the instant invention to provide a method for protecting a substrate from physical damage, water damage, corrosive and thermal exposure comprising the steps of: a) providing a homogeneous mixture comprising polyurea and components that impart reflective, emissive and insulating properties; and b) applying the homogeneous mixture of step (a) to the outer surface of said substrate wherein upon curing of said homogeneous mixture said substrate is protected from corrosive and thermal exposure.

It is still a further objective of the instant invention to provide a product for reducing thermal and radiant energy transmission/absorption comprising a polyurea vehicle containing components that impart reflective, emissive and insulating properties for its use.

Other objectives and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

Definitions

The following list defines terms, phrases and abbreviations used throughout the instant specification. Although the terms, phrases and abbreviations are listed in the singular tense the definitions are intended to encompass all grammatical forms. As used herein, the abbreviation “UV” refers to ultraviolet radiation.

As-used herein, the abbreviation “VOC” refers to a volatile organic compound.

As used herein, the term “protective” is defined as providing a defense or shield against harm, for example, a defense against environmental exposure.

As used herein, the term “homogeneous mixture”is defined as a composition comprising at least two materials which is applied in a single layer.

As used herein, the term “substrate” is defined as any material or surface which is exposed to environmental harm, such as mechanical, thermal and corrosive stress.

As used herein, the term “curing” is defined as perfecting a material by chemical change, for example, treatment by heat and/or chemicals to make insoluble.

As used herein, the term “container” is defined as any material, object or structure enclosing a hollow space. Illustrative, albeit non-limiting, examples of containers are buildings, ships, vehicles and railway cars. A particularly preferred example of a container as used herein is a railway, car.

As used herein, the term “polyurea” refers to an elastomer that is derived from the reaction product of an isocyanate component and a resin blend component. The isocyanate can be aliphatic or aromatic and it can be a monomer, polymer or any variant reaction of isocyanates, quasiprepolymer or a prepolymer. The prepolymer or quasiprepolymer can be made of an amine-terminated-polymer resin or a hydroxyl-terminated polymer resin. The resin blend must be made up of amine-terminated polymer resins, and/or amine-terminated chain extenders., The amine-terminated polymer resins will not have any intentional hydroxyl moieties. The resin blend may contain additives or non-primary components but does not normally contain a catalyst. There are many advantages to using polyurea, including no VOC's, little odor, fast-curing, weather-tolerant, resistance to thermal shock, flexible, waterproof, seamless, unlimited thickness obtainable in one application and chemical resistance. This definition was developed by the Polyurea Development Association and can be accessed through the polyurea website.

As used herein, the term “diffuse reflectivity” applied to a coating formulation refers to an increase in surface area, usually by the addition of microscopic granular components to the formulation; typically in the micrometers to nanometer range. Diffuse reflectivity is attended by an increase in solar, hemispherical and UV emissivity.

“Emissivity” as defined here is the property by which radiant energy is not retained by matter, but is rapidly emitted back into the environment and thus not available for transduction into heat energy.

As used herein, the term “energy emissive microsphere” refers to a small, usually at least partially hollow, sphere that is capable of emitting energy. Illustrative, albeit, non-limiting examples of microscopic granules capable of imparting the property of diffuse reflectivity and emissivity are borosilicate microspheres, silicon nitride microspheres and glass or polystyrene beads. A particularly preferred microsphere for use with the instant invention is an evacuated borosilicate microsphere.

As used herein, the term “borosilicate microsphere” is defined as a hollow sphere comprising an outer shell of boron and silicate. The borosilicate microsphere can be partially or completely evacuated. A particularly preferred borosilicate microsphere for use with the instant invention is completely evacuated.

### DETAILED DESCRIPTION OF THE INVENTION

The instant invention takes advantage of the property of diffuse reflectivity that results in increased emittance. Diffusion of reflectance is obtained by the use of granular agents in the micrometer and nanometer range to dramatically increase the surface area of the exposed surface to which this technology is applied. When this principal is applied in formulations with ingredients that have high reflectivity and which insulate, the result is a dramatic reduction in transmitted temperature because it effects all three mechanisms of heat transfer: radiation, convection, and conduction. For example, when this technology is applied in such a manner that a coating is made with a bright white pigment that results in a reflectivity of 80%, and this reflectivity is enhanced by adding highly microscopic granules that impart the properties of diffuse reflectivity and resultant emissivity resulting in a combined emittance and emissivity of 90%, then of the 20% of the incident electromagnetic energy striking the surface that is not reflected, 90% of that energy is rapidly emitted and thus not available to be transduced into heat energy. Thus, with 80% of the energy reflected and 18% of the non-reflected energy emitted back into the atmosphere, only 2% of the incident energy striking the surface is available to be transduced by electronic excitation of surface molecules and used as heat. The process of waste heat generation is inefficient so that only a small percentage of the available 2% energy of the electromagnetic-energy that is neither reflected or emitted is actually transduced into heat energy. Further, if the granular agent used consists of evacuated microspheres that also insulate the surface to which the coating is applied, the surface is protected from a substantial amount of, even the small amount of heat energy formed. Thus, when the carrier of the highly emissive microspherical granules is polyurea, aliphatic, aromatic, or any hybrids derived therefrom, the aforementioned features and advantages will be appreciated and understood by those skilled in the art.

The polyurea spray elastomeric systems require no catalyst(s) and are extremely fast in reactivity and cure rate. Curing of polyurea is well-known and one of skill in the art would be familiar with the techniques. Aromatic and aliphatic polyurea spray elastomeric systems are easily achieved by changes in formulation composition, and they are 100% solids, devoid of toxic organic solvents. These spray systems have excellent mechanical properties, such that due to the fast reaction rates and cure of the polyurea elastomer systems, sloped or vertical surfaces can be sprayed without forming runs or drips. Surfaces can be walked on within seconds after-spraying. The amorphous, non-crystalline, nature of the present invention as compared to polyurethane, allows for broader processing and performance latitudes and extended durability when subjected to extreme environmental conditions. The resin blend of polyurea is composed of amine terminated resins and amine terminated chain extenders, and no polyols. As the preferred carrier for the instant invention, polyurea demonstrates:
1) Excellent mechanical properties and extended durability, even in extreme environmental conditions; and
2) Fast consistent reactivity that is relatively unaffected by changes in humidity and temperature. No catalysts are required.

The preferred carrier, polyurea, has advantages over other carriers such as epoxy, polyurethane and polyesters as well as polyethylene and polypropylene sheet goods.

Polymer systems based on polyurethane, epoxy and acrylics usually require at least a 12 hour cure period, and in some cases 24 hours, before the coated area can be put into service. Due to the fast consistent reactivity and cure times of the preferred carrier polyurea, coating applications can easily be returned to service in a 1 to 3 hour time period. This technology can even be applied at −20° C. ambient temperature and reach service cure within 1 hour. Similarly, high humidity that would obviate the application of acrylics or other coatings does not inhibit the instant invention. Additionally, the technology has an added feature of being 100% solids with no volatile organic compounds (VOC's).

It has further been determined in demonstrating the purpose of the instant invention that the addition of microscopic particles as described above to the B side of the polyurea-system in a range of inclusion of from 0.2 to 8 oz. per gallon of the B side (Polyurea is generally referred to as a two side system; one side is referred to as the isocynate side and the other side is the polyol side. The microspheres and synthetic fillers are added to the polyol side, which is commonly referred to as the “B side”. One of skill in the art would be familiar with this polyurea terminology.) in particle size of 2 to 25 microns that a surprising effect occurs as stated below, a solar reflectance and thermal emittance is displayed with the inclusion of the microscopic granules. While these energy emissive microscopic granules are preferably hollow borosilicate microspheres, and most preferably evacuated borosilicate microspheres, alternative materials are, for example, silicon nitride, glass beads, and the like. It should be noted that another attribute of the preferred agent, evacuated borosilicate microspheres, is its insulating property. A 20 mil coating provides an equivalent insulating R value equal to 5.

Hemispherical emittance was calculated from normal emittance by using equations 4 and 5 provided by the National ating Council in NFRC 301-93. Hemispherical spectral reflectance measurements were performed in accordance with ASTM standard Test Method E 903-88 (1992). The measurements were performed with a Beckman 5240 Spectrophotometer utilizing an integrating sphere (Fig A 1.3 of E 903 88(1992). Total reflectance measurements were obtained in the solar spectrum from 2500 nm to 300 nm at an incident angle of 15°. The measurements employ a detector baffled wall-mounted integrating Sphere that precludes the necessity of employing a reference standard except to define the instruments-100% line. The measurements are properly denoted as being “hemispherical spectral reflectance”. The spectral data were integrated against Air Mass 1.5 global (ASTM E892-87(1992), Table 1 spectrum utilizing 109 weighted ordinates. The UV region of the spectral data (300 to 400 nm) was integrated using 15 weighted ordinates from Air Mass 1.5 global spectrum. The visible region of the spectral data (410 to 722 nm) was integrated using 25 weighted ordinates from Air Mass 1.5 global spectrum. The NIR region of the spectral data (724 to 2500 nm) was integrated using 69 weighted ordinates from the Air Mass 1.5 global spectrum. All measurements were performed on the coated surface. The values reported for emittance represent the average of at least Four Measurements.

EMITTANCE

| 1) | Reflectance | Near Normal | Hemispherical |
|---|---|---|---|
| Specimen Code | Measured | Emittance | Emittance |
| 7779-7-5-1 | .05 | 95 | .90 |
| 7779-7-5-2 | .05 | 95 | .90 |

| | | |
|---|---|---|
| 2) | REFLECTANCE | % REFLECTANCE |

| Specimen Code | UV | VIS | NIR | SOLAR |
|---|---|---|---|---|
| 7779-7-5-1 | 19.09 | 91.4 | 76.9 | 80.7% |
| 7779-7-5-2 | 19.5 | 91.3 | 76.9 | 80.6% |

Near-Normal emittance specimens were calculated from Kirchoff's Relationship. The instant invention further demonstrates the value of the inclusion of microspheres, preferably totally evacuated borosilicate microspheres, in their performance when incorporated into different colors (pigments).

| | Solar | Thermal |
|---|---|---|
| | Reflectance | Emmitance |
| a) Borosilicate Coating White | 80.7 | .91 |
| b) Borosilicate Coating Beige | 59.6 | .87 |
| c) Borosilicate Coating Coral | 67.8 | .87 |
| d) Borosilicate Coating Apple Red | 42.6 | .89 |

Where heretofore colors in other coatings were restricted to white or bright white, the instant invention demonstrates that in the present invention non-white colors are capable of reducing heat load transfers. Additionally, the instant invention, even with different pigments added, will not only reduce heat generation but also will reduce UV degradation and the effects of ionization, thereby protecting the substrate from deterioration. Further by reducing the generation of heat from electromagnetic radiation the instant invention-protects substrates by minimizing or eliminating heat cycling due to expansion and contraction resulting from daily exposure to sunlight.

Further, it has been determined that by adding a synthetic filler to the instant invention where colors, or pigments-are used, and where titanium dioxide is used especially in white pigmented coatings, but not limited to, these fillers are extremely bright and can be used as a titanium dioxide extender. These synthetic fillers will add brightness to colors and act as an additional UV reflector to slow down the UV deterioration of color process adding extended color retention as well as adding an increased gloss to the finish of the protective coating of the instant invention where desired.

The synthetic of choice is commercially available and produced by the J. M. Huber Corporation under the Registered Trademark name HYDREX R, a synthetic-sodium magnesium aluminosilicate filler, which adds reinforcing properties to the instant invention along with increasing tensile strength and abrasion resistance.

Further to the attributes of the instant invention, it is known that the containers used for the transport and storage of fuels such as gasoline, propane, jet fuel, benzene, diesel fuel, natural gas, and crude oil, by example only, are temperature sensitive and thus the application of the protective coating of the instant invention will have a major positive impact on the fuels industry. For example, the product of the instant invention will reduce the overall temperature of stored fuels such as gasoline and propane in hot climates by the application of this new radiation control technology that can reflect (˜80%) of the surface radiation and shed (˜90%) stored heat by emitting near and far infrared radiation to the surroundings

In theory, a reduction in temperature would reduce vapor pressure and allow for higher fill levels. Present limitations-assume that fuels stored or transported will undergo heating. Standards, such as ASME Pressure and Vessel Codes, specify required tank strengths and require a high margin of safety. Further, pressure relief valves set at 40% (as an example) of the tank strength prevent tank ruptures when fuels heat and vapor pressure rises. In physical theory, seasonal weather factors affect the amount of fuel allowed such that vapor pressure will not cause a release of the release valves and suggest higher limits could be maintained at lower temperatures. Temperature and pressure data-selected for commonly stored and transported fuels is found in a number of references that would be familiar to one of skill in the art.

Gasoline is derived from the fractional distillation of petroleum. Ordinary gasoline consists of the hydrocarbons between C₆H₁₄ hexane, C₆₂₂, which will distill of fat temperatures of 69° C. and 174° C. (156° F. and 345° F.), usually having the light limit at heptane or octane. Variations include Gasohol (20% gasoline, 5% kerosene and 75% ethyl alcohol), used in the Philippines and German Dynokol (70,% gasoline with alcohol and benzol). Another hydrocarbon fuel is propane, a commonly used fuel. Normally propane is used in combination as a vapor at moderate temperatures but is stored and transported in liquid form. Natural gas can also be transported in liquid (−153° C., 243° F.) form, the principal component of which is the gas methane (hydrocarbon). A cursory evaluation of the above, by example, indicates that the instant invention would have a positive impact on the storage and transportation vessels of various fuels by the reduction of transferred heat. The highest economic impact will probably be on the transportation costs of natural-gas (methane) and propane. In the case of propane, a 21%-24% reduction in saturation pressure is seen for every drop in liquid temperature. This is significant given pressures of hundreds of pounds-per-square inch.

Further benefits of the protective coating of the instant invention are that it has additional importance when applied, by example and not limited to, metal surfaces such as railcar's, transport vehicles, pipelines, and outside storage facilities; especially those that contain various fuels and additionally, will have a positive effect on the vessels used in the storage and transport of perishable foods and food products where temperature can play a factor in preservation and stability. As an example, it is known that high temperatures can have an adverse effect on wine and that: 1) Shipping temperatures should be minimized to maintain the wine in the best general condition; 2) Color in wines will dramatically change with higher temperatures for even short periods of time and 3) White color will increase, red color will decrease, and acetate esters will rapidly become hydrolyzed.

Further, it is known that temperature control is of major importance in the transport of materials illustrated by, albeit not limited to, grains, dairy products and natural food grade oils. Additionally, the instant invention, when applied to vessels and storage facilities that are refrigerated or air conditioned, will reduce the energy/fuels used to maintain proper temperature controls in that the reflective emissive, and insulating properties of the instant invention reduces the heat generation and transmission, thereby reducing the amount of energy needed to maintain the desired temperature levels. Thus, the protective coating of the instant invention provides a unique method of protection to those materials and commodities transported or stored, against degradation, expansion, and reduced energy costs by the application of the present invention, a fast curing elastomeric material, preferably polyurea which contains microscopic granules capable of imparting the properties of diffuse reflectivity and emissivity, preferably evacuated; borosilicate microspheres between 2 and 25 microns, provides high corrosion resistance, wide spectrum of chemical resistance, a moisture proof, barrier, the use of multiple colors (pigments) and provides a seamless, monolithic, conformal body of elastomeric material.

In conclusion, the instant invention provides a strong, waterproof, impact and corrosion resistant coating comprising a homogeneous mixture of polyurea and microscopic granules capable of imparting the property of diffuse reflectivity and emissivity and its method of use as a means for reduction of thermal and radiant energy transmission and absorption when applied to the outer surface of an object or container. The protective coating of the instant invention will substantially reduce the internal temperatures of storage, transport containers, transport vehicles and flow conduits and mechanisms exposed to radiant energy that is comprised of reflective and emissive materials, such that microscopic granules are used to increase the surface area to create diffuse reflectivity and the consequential increase in emittance.

All patents and publications mentioned in this specification are indicative of the levels of those skilled in the art to which the instant invention pertains. All patents and publications are herein incorporated by reference to the same extent as if each individual patent and publication was specifically and individually indicated to be incorporated by reference.

It is to be understood that while a certain form of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification.

One skilled in the art will readily appreciate that the present invention is well adapted to carry out the objects and obtain the ends and advantages mentioned, as well as, those inherent therein. The methods, procedures and techniques described herein are presently representative of the preferred embodiments, are intended to be exemplary and, are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed various modifications of the described modes for carrying out the invention which are obvious to those skilled in the art are intended to be within the scope of the following claims.

1. A protective coating comprising a homogeneous mixture of polyurea and microscopic granules thereby providing a property of diffuse reflectivity.

2. The protective coating in accordance with claim 1 wherein said microscopic granules are added to said homogeneous mixture in a range of inclusion from 0.2 to 0.8 ounces per gallon of said polyurea.

3. A protective coating in accordance with claim 1 wherein said microscopic granules capable of imparting the property of diffuse reflectivity range in size from 2 to 25 microns.

4. A protective coating in accordance with claim 2 wherein said microscopic granules capable of imparting the property of diffuse reflectivity range in size from 2 to 25 microns.

5. A protective coating in accordance with claim 1 wherein said homogeneous mixture further comprises a colored pigment.

6. A protective coating in accordance with claim 2 wherein said homogeneous mixture further comprises a colored pigment.

7. A protective coating in accordance with claim 3 wherein said homogeneous mixture further comprises a colored pigment.

8. A protective coating in accordance with claim 4 wherein said homogeneous mixture further comprises a colored pigment.

9. A protective coating in accordance with claim 1 wherein said homogeneous mixture further comprises a synthetic filler.

10. A protective coating in accordance with claim 2 wherein said homogeneous mixture further comprises a synthetic filler.

11. A protective coating in accordance with claim 3 wherein said homogeneous mixture further comprises a synthetic filler.

12. A protective coating in accordance with claim 4 wherein said homogeneous mixture further comprises a synthetic filler.

13. A protective coating in accordance with claim 5 wherein said homogeneous mixture further comprises a synthetic filler.

14. A protective coating in accordance with claim 6 wherein said homogeneous mixture further comprises a synthetic filler.

15. A protective coating in accordance with claim 7 wherein said homogeneous mixture further comprises a synthetic filler.

16. A protective coating in accordance with claim 8 wherein said homogeneous mixture further comprises a synthetic filler.

17. A protective coating in accordance with claim 9 wherein said synthetic filler is sodium magnesium aluminosilicate.

18. A protective coating in accordance with claim 10 wherein said synthetic filler is sodium magnesium aluminosilicate.

19. A protective coating in accordance with claim 11 wherein said synthetic filler is sodium magnesium aluminosilicate.

20. A protective coating in accordance with claim 12 wherein said synthetic filler is sodium magnesium aluminosilicate.

21. A protective coating in accordance with claim 13 wherein said synthetic filler is sodium magnesium aluminosilicate.

22. A protective coating in accordance with claim 14 wherein said synthetic filler is sodium magnesium aluminosilicate.

23. A protective coating in accordance with claim 15 wherein said synthetic filler is sodium magnesium aluminosilicate.

24. A protective coating in accordance with claim 16 wherein said synthetic filler is sodium magnesium aluminosilicate.

25. (withdrawn) A process for reducing thermal and radiant energy transmission and absorption of a substrate comprising the steps of:
(a) providing a homogeneous mixture comprising polyurea and microscopic granules that impart diffuse reflectivity; and
(b) applying the homogeneous mixture of step (a) to an outer surface of said substrate;
wherein upon curing of said homogeneous mixture upon said substrate, thermal and radiant energy transmission and absorption of said substrate is reduced.

26. (withdrawn) A process for protecting a substrate from thermal and corrosive exposure comprising the steps of:
(a) providing a homogeneous mixture comprising polyurea and microscopic granules that impart diffuse reflectivity; and
(b) applying the homogeneous mixture of step (a) to an outer surface of said substrate;
wherein upon curing of said homogeneous mixture upon said substrate, said substrate is protected from mechanical, water and corrosive damage, and thermal exposure.

27. A protective coating comprising a homogeneous mixture of polyurea and borosilicate microspheres.

28. The protective coating in accordance with claim 27 wherein said borosilicate microspheres are added to said homogeneous mixture in a range of inclusion from 0.2 to 0.8 ounces per gallon of said polyurea.

29. A protective coating in accordance with claim 27 wherein said borosilicate microspheres range in size from 2 to 25 microns.

30. A protective coating in accordance with claim 28 wherein said borosilicate microspheres range in size from 2 to 25 microns.

31. A protective coating in accordance with claim 27 wherein said homogeneous mixture further comprises a colored pigment.

32. A protective coating in accordance with claim 28 wherein said homogeneous mixture further comprises a colored pigment.

33. A protective coating in accordance with claim 29 wherein said homogeneous mixture further comprises a colored pigment.

34. A protective coating in accordance with claim 30 wherein said homogeneous mixture further comprises a colored pigment.

35. A protective coating in accordance with claim 27 wherein said homogeneous mixture further comprises a synthetic filler.

36. A protective coating in accordance with claim 28 wherein said homogeneous mixture further comprises a synthetic filler.

37. A protective coating in accordance with claim 29 wherein said homogeneous mixture further comprises a synthetic filler.

38. A protective coating in accordance with claim 30 wherein said homogeneous mixture further comprises a synthetic filler.

39. A protective coating in accordance with claim 31 wherein said homogeneous mixture further comprises a synthetic filler.

40. A protective coating in accordance with claim 32 wherein said homogeneous mixture further comprises a synthetic filler.

41. A protective coating in accordance with claim 33 wherein said homogeneous mixture further comprises a synthetic filler.

42. A protective coating in accordance with claim 34 wherein said homogeneous mixture further comprises a synthetic filler.

43. A protective coating in accordance with claim 35 wherein said synthetic filler is sodium magnesium aluminosilicate.

44. A protective coating in accordance with claim 36 wherein said synthetic filler is sodium magnesium aluminosilicate.

45. A protective coating in accordance with claim 37 wherein said synthetic filler is sodium magnesium aluminosilicate.

46. A protective coating in accordance with claim 38 wherein said synthetic filler is sodium magnesium aluminosilicate.

47. A protective coating in accordance with claim 39 wherein said synthetic filler is sodium magnesium aluminosilicate.

48. A protective coating in accordance with claim 40 wherein said synthetic filler is sodium magnesium aluminosilicate.

49. A protective coating in accordance with claim 41 wherein said synthetic filler is sodium magnesium aluminosilicate.

50. A protective coating in accordance with claim 42 wherein said synthetic filler is sodium magnesium aluminosilicate.

51. (withdrawn) A process for reducing thermal and radiant energy transmission and absorption of a substrate comprising the steps of:
(a) providing a homogeneous mixture comprising polyurea and borosilicate microspheres; and
(b) applying the homogeneous mixture of step (a) to an outer surface of said substrate;
wherein upon curing of said homogeneous mixture upon said substrate thermal and radiant energy transmission and absorption of said substrate is reduced.

52. (withdrawn) A process for protecting a substrate from thermal and corrosive exposure comprising the steps of:
(a) providing a homogeneous mixture comprising polyurea and borosilicate microspheres; and
(b) applying the homogeneous mixture of step (a) to an outer surface of said substrate;
wherein upon curing of said homogeneous mixture upon said substrate said substrate is protected from thermal and corrosive exposure.
